(19) United States
(12) Patent Application Publication
(10) Pub. No.: US 2009/0265423 A1
(43) Pub. Date: Oct. 22, 2009

(54) METHOD AND SYSTEM OF MOBILE APPLICATION IMPLEMENTATION ON NETWORK SERVER

(75) Inventors: Sunil MAHAJAN, Gurgaon (IN); Vivek WAMORKAR, Bangalore (IN); Bharath CHIKKANAHALLI, Bangalore (IN)

Correspondence Address: Workman Nydegger;1000 Eagle Gate Tower, 60 East South Temple, Salt Lake City, UT, 84111, US

(73) Assignee: ARICENT INC., George Town (KY)

(21) Appl. No.: 12/424,041

(22) Filed: Apr. 15, 2009

(30) Foreign Application Priority Data
Apr. 16, 2008 (IN) 19/DEL/2008

(51) Int. Cl. G06F 15/16

(52) U.S. Cl. 709/203; 715/764

(57) ABSTRACT

The invention discloses a communication system having mobile applications implemented on a server. The disclosed system has a server component, a client component and a communication component. The server component facilitates atleast one of: creation, installation, upgradation, distribution, customization, maintenance, removal or discovery of the mobile applications on the server. The client component has a user interface and a display. The client component facilitates interaction with the server component. The communication component facilitates communication between the server component and the client component.

### BACKGROUND OF THE INVENTION

1. Field of the Invention

The present invention generally relates to the field of client-server systems. More particularly, the present invention relates to implementation of mobile applications on a network server.

2. The Relevant Technology

Electronic communication devices like mobile phones, smart telephones, personal digital assistants (PDAs), laptop, personal computers and other electronic communication devices are widely used for personal, professional and business purposes. These electronic communication devices have gone beyond luxury to being necessity with the current globalization and also due to need for better and remote availability of sharable information. Further, these electronic communication devices have undergone significant change in terms of processor, memory and software applications and this has resulted into increased number of facilities provided by these electronic communication devices.

Today, an electronic communication device is not only a device for voice communication or text messaging but a complete tool to do lot of other activities. With integrated camera, large storage, online email, e-commerce applications etc. electronic communication device is becoming single companion for most of the users and replacing multiple accessories for end users by a single device. The electronic communication devices have gone past voice only electronic communication devices to reach status of devices with true multimedia capabilities that includes video communication, and other entertainment possibilities, like TV on mobile, video streaming, gaming etc. As usage of electronic communication devices have increased, a market for products and services related to electronic communication devices has developed. Users of electronic communication devices are provided with a wide variety of software, mobile applications and service choices to enhance the features and usage capabilities of electronic communication devices.

Clearly, electronic communication devices are becoming more and more sophisticated and networks are increasingly offering more bandwidth, which is making it possible to create more services/applications for end users. However, with more sophisticated devices and more complex mobile environments, it is becoming difficult for both end users and operators to manage these devices. With large number of electronic communication devices in any network it will be a humongous task to manage these devices remotely. For network operators or service providers it's a big task to keep every application on every device updated, customize every application on every device as per user's choice, remove mis-behaving applications, upgrade applications for newer versions, and support applications for large number of platforms. And all this has to be done remotely, without calling customer or without requesting customer to visit operators support centers. For users it's a similar challenge, with increasing availability of large number of applications, user has to manage all of them on his local device—what application, what interface, licensed or non-licensed, operator supported or free, upgrade required, local customization, different look and feel of each application etc. This all has to be managed by end user and that too for a large number of applications on his/her device.

Thus, there is a need for methods and systems to thwart the requirement of complex remote application management on electronic communication devices both for operators and end-users.

### SUMMARY OF THE INVENTION

These and other drawbacks and limitations are overcome by embodiments of the present invention, which relates to systems and methods to implement mobile applications on a network server instead of the way known in prior art of implementing them on an end-user electronic communication device.

The invention discloses a communication system having mobile applications implemented on a server. The disclosed system has a server component, a client component and a communication component. The server component facilitates atleast one of: creation, installation, upgradation, distribution, customization, maintenance, removal or discovery of the mobile applications on the server. The client component has a user interface and a display. The client component facilitates interaction with the server component. The communication component facilitates communication between the server component and the client component.

The invention discloses a method of implementing one or more mobile applications for an electronic communication device, on a network server. The method includes selecting a mobile application from a plurality of mobile applications available to an end user. Executing the selected mobile application on a network server, such that the selected mobile application is installed on the network server. Providing a user interface of the selected mobile application, on the electronic communication device enabling the user of the electronic communication device to access the selected mobile application over a network through the user interface.

In one embodiment the invention discloses a method of discovering mobile applications deployed on the network server. Providing an indication of the discovered mobile application to the electronic communication device on a user interface. Selecting atleast one mobile application from the available mobile applications for implementation of the selected mobile application on the network server.

In yet another embodiment of the present invention, the electronic communication device interacts with the selected mobile application on the server, to only display user interface of the selected mobile application and to provide inputs through the user interface of the selected mobile application for execution of the selected mobile application on the network server. There is no mobile application download or mobile application execution on the electronic communication device. The complete mobile implementation, from discovering mobile applications to execution of the discovered mobile applications is done by the network server.

In yet another embodiment of the present invention, the network server facilitates creation, installation, distribution, upgradation, maintenance, execution, removal and customization of the mobile applications on the network server. The server also facilitates simultaneous execution of multiple mobile applications.

In yet another embodiment, the present invention defines methods and systems, which can help operator to reduce the complexity of application management by reducing the dependency of application on electronic communication devices. The present invention helps in quick deployment of new applications on the electronic communication device.

Though this invention's first application is mobile networks and mobile applications, but the methods and systems described herein can be applied to any other the electronic communication device (fixed or mobile). These and other novel features of the invention will become apparent from following detailed description of the invention when considered in conjunction with the drawings.

### BRIEF DESCRIPTION OF THE DRAWINGS

FIG. 1 illustrates an exemplary view of the present invention.

FIG. 2 illustrates an exemplary view of client-server architecture according to an embodiment of the present invention.

FIGS. 3a-3f illustrate exemplary views of the user perspective of the invention, from discovery to implementation of mobile applications, according to an embodiment of the present invention.

FIG. 4 illustrates an exemplary flow diagram of the present invention.

### DETAILED DESCRIPTION OF THE INVENTION

The present invention is now described with reference to the drawings. While explaining various aspects and features of the invention, like reference numerals are used to refer to like elements and\or structures. Like reference numerals shows the usage of like element in various embodiments of the inventions. The figures, drawings and block diagrams used to explain various embodiments of the present invention are for explanatory purpose and are not limiting of the present invention.

As used in the subsequent paragraphs, the term “mobile application” is intended to refer to logic code applications, software or setups. Further “mobile application” can be, not limited to though, text message applications, voice calling, games, e-commerce facilitator, communication protocols, audio\video software etc. These mobile applications may also include logical program codes (software setups) which enhance usability, processing, look and feel of electronic communication devices. For example, a mobile application can be, but is not limited to being, an object, software for upgradations, new installation setups, new mobile applications or an executable code.

Also, the term “component” is intended to refer to a computer-related entity, either hardware, a combination of hardware and software, software, or software in execution. By way of illustration, both an application running in a mobile computing device and the mobile computing device can also be considered as a component. One or more components may reside within a process and/or thread of execution and a component may be localized on one computer and/or distributed between two or more computers connected over a network.

Further, the terms “server” and “network server” have been used interchangeably and both the terms refer to the network server, as described in the detailed description of the invention. These terms have been used to facilitate the description of the illustrated embodiments of the invention and are not intended to limit the scope of the invention

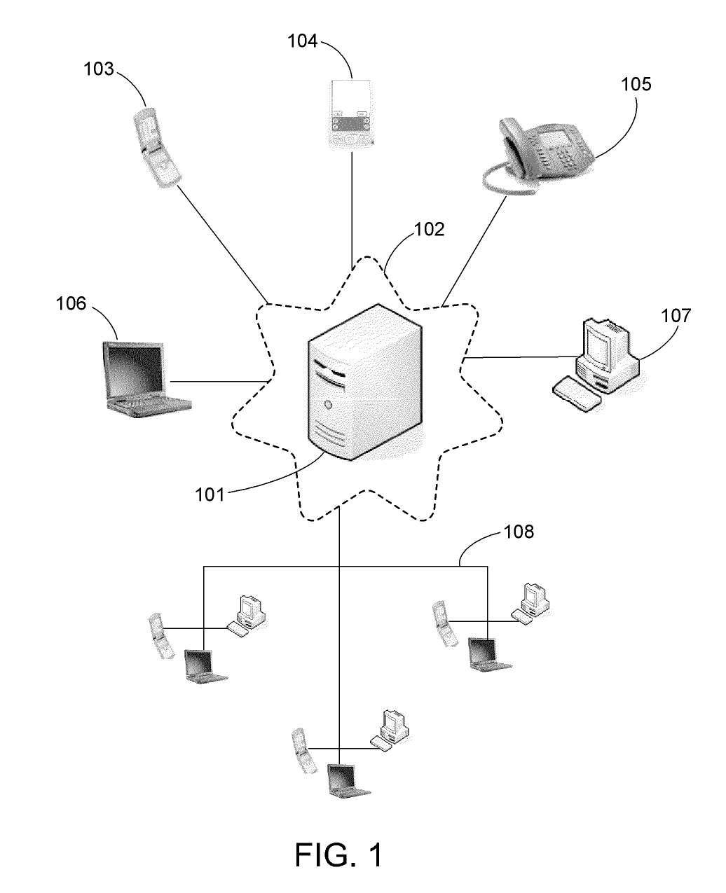

The present invention relates to systems and methods of implementing mobile applications that are used by the electronic communication device user, on a network server rather than on the actual electronic communication device as known in prior art. Referring to FIG. 1, there is illustrated a general diagram of various electronic communication device which may be used with a server 101 to realize the invention and its various embodiments. The various electronic communication devices like mobile phone 103, personal digital assistant 104, fixed line phone 105, laptop 106, personal computer 107 and other electronic communication devices are used on the client side of client-server architecture with the server 101. For the purpose of simple description of the invention, mobile phone 103 and server 101 would be used for explaining various embodiments of the invention. It would be evident to one skilled in the relevant art, however, that the invention can be practiced with personal digital assistant 104, fixed line phone 105, laptop 106, personal computer 107 and other existing and future communication devices. Further, the electronic communication device like mobile phone 103, personal digital assistant 104, fixed line phone 105, laptop 106, personal computer 107 and other electronic communication devices can be logically connected to form a community 108.

In a typical mobile communication scenario, an operator makes available to its users a variety of mobile applications. As per the methods and systems used in prior art, when a user desires to use a mobile application, he downloads the setup (a logical program code) of the mobile application on his electronic communication device. The setup is then executed on the electronic communication device and the output from the execution of the device is made available to user for his use. For example, a user desires to have a new chess game application on his electronic communication device. In order to get the chess game application, he logs onto a portal which facilitates download of the chess game application. The portal may require the user to register as a subscriber before the user can use various services offered by the portal. The user then selects a desired version of the chess game, which may be selected from a list of plurality of chess game applications available on the portal and downloads the logical program code (software setup) of the desired chess game application on his electronic communication device. The user executes the logical program code on his mobile in order to install the desired chess player application on his electronic communication device. Subsequently, at any point of time user operates the downloaded chess game on his electronic communication device, the execution of the chess application would always take place on the user's electronic communication device.

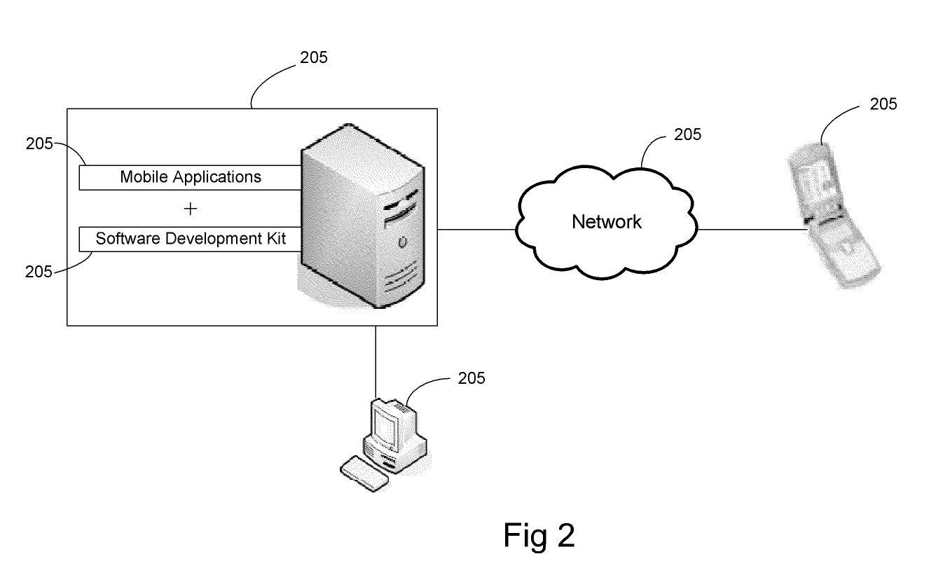

Referring now to FIG. 2, there is illustrated an exemplary view of client-server architecture. The electronic communication device 204 is connected to a server 201 through a network 203. The electronic communication device 204 carries a network based application (NBA) client to facilitate communication with the server 201 where the server 201 performs mobile application discovery, implementation and session management in conjunction with the NBA client. The server 201 also facilitates multiple simultaneous executions of mobile applications 205 for the electronic communication device 204. One of these mobile applications 205 controls the user interface of the electronic communication device 204. The user of the electronic communication device 204 may indicate an act of switching between pluralities of mobile applications 205 by, not limited to, press of key or any such indicator. The user indication would result in an indication being sent to server 201 over the network 203 that would cause the server 201 to switch the user interface between pluralities of mobile applications 205. The electronic communication device 204 and server 201 need data connection for communication, which could be a GPRS connection for GSM networks or could be any wireless or fixed connection.

In one embodiment the server 201 has a plurality of mobile applications 205 available on it. A user of the electronic communication device 204 desires to use one of the pluralities of mobile applications available on the server 201. The user may provide an indication by means of device supported mechanisms, examples of which include but are not limited, to text input, keystroke, pressing of a button or a touch on electronic communication device 204, to initiate discovery of mobile applications available at the server 201. Further, the indication for discovery of mobile applications may include manual or automated means. The indication for discovery of mobile applications 205 is handled at the network server 201 and the network server 201 pushes the list of applications to the electronic communication device 204, in response, by creating and pushing a corresponding user interface onto display associated with the electronic communication device 204.

The user of electronic communication device 204 selects one of the pluralities of discovered mobile applications through device supported input mechanisms and the corresponding user interface (front-end) of the selected mobile application is pushed onto the electronic communication device 204 from the server 201. Through user interface of the selected mobile application, inputs on execution of the selected mobile application are provided by the user of the electronic communication device 204. The execution of the selected mobile application takes place on the network server 201. The outputs from the executions of the selected mobile application are transmitted from the network server 201 to electronic communication device 204 for its use. There will not be any download or logic execution of the mobile applications 205 on the electronic communication device 204 as complete execution of the mobile applications 205 is handled by the network server 201. Further, the network server 201 can simultaneously execute multiple mobile applications.

In another embodiment of the present invention, the electronic communication device 204 can have a pre-determined list of pluralities of mobile application 205 hosted on the server 201. The user of electronic communication device 204 selects one of the pluralities of mobile applications 205 from the pre-determined list of pluralities of mobile application 205. The execution of the selected mobile application takes place on the network server 201 and outputs are transmitted from the network server 201 to electronic communication device 204.

Thus the systems and methods of the present invention has advantage over the prior arts as execution of the mobile applications 205 take place on the server 201. By implementing mobile applications 205 in the server 201, dependency on electronic communication device 204 reduces significantly and there is no burden of availability of memory space on the electronic communication device 204. Thus, operators can launch new mobile applications 205 even if they require high computing and memory on low-end electronic communication device or mobile phones like 204. With available prior art, such mobile applications requiring high computing and memory could have been launched only on high-end electronic communication devices. This invention thus helps increase the coverage of mobile applications to a larger community as dependence on electronic communication device 204 has been removed by execution of mobile application on network server 201.

Another advantage associated with the present invention is that, functions such as mobile application distribution, mobile application upgrade, mobile application customization, mobile application discovery, mobile application look and feel and maintenance of mobile applications will become centralized in server 205. Per user customized user interfaces and new mobile application interfaces can be pushed without any change to the electronic communication device 204. Even a new version of an existing mobile application can be supported without any change to electronic communication device 204. Thus, the end-user will be totally relieved of all mobile application management functions on electronic communication device 204 and the mobile application 205 maintenance responsibilities of network operators or service providers simplifies to great extent.

In addition, the invention provides the operator with an opportunity to deliver per user customized user interface. The network server 201 can be configured to facilitate automatic creation, installation, distribution, upgradation, maintenance, execution, removal or customization of user interfaces of the mobile applications.

Moreover, since mobile applications 205 are controlled by the network server 201, there is no way mobile applications 205 can corrupt or disrupt electronic communication devices 204. Since there is no download, this system does not require any application level encryption or DRM method to be deployed on the electronic communication devices 204.

Also shown in FIG. 2, is a portal 202 to facilitate and manage subscription of the mobile application 205 residing on the server 201 for the plurality of the electronic communication device 204. The portal 202 can be an internet website, an intranet website or a front end of a database having mobile applications or any other means which facilitates management and subscription of mobile applications. The portal 202 can reside on the server 201. Further, the portal 202 allows specification of subscription parameters that decide access to each application by individual electronic communication device.

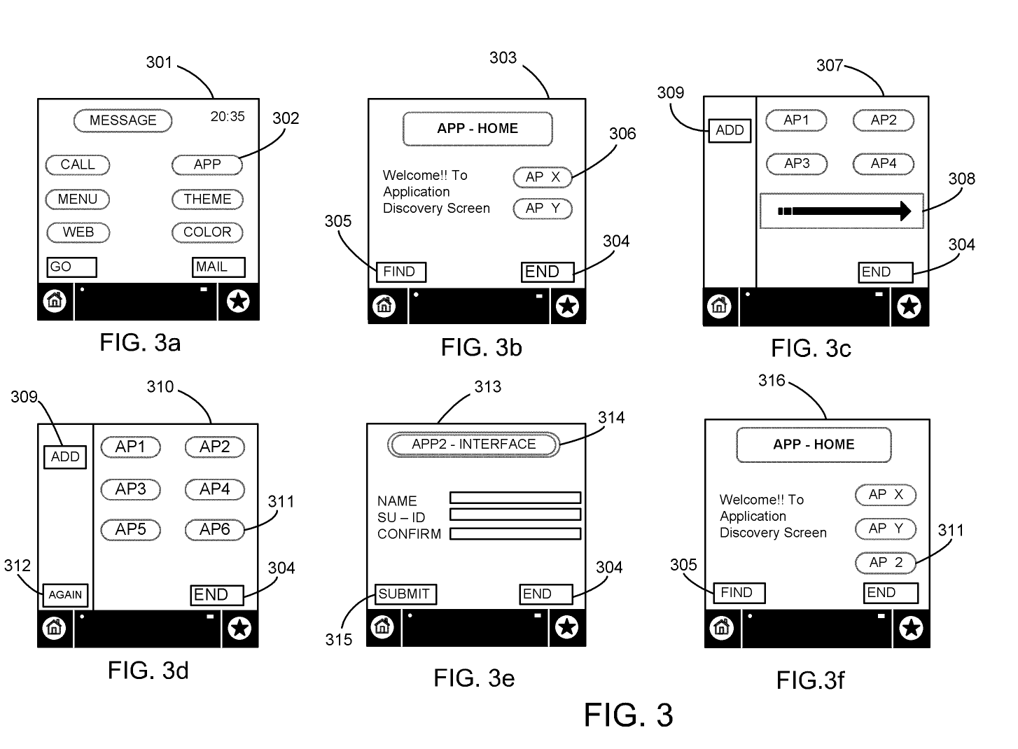

Referring now to FIG. 3, there is illustrated a user perspective of the working of the present invention. A home screen 301 of an electronic communication device generally consists of icons linked to functions like call, phone settings, web browser or any other mobile application. The home screen 301 of the electronic communication device can be configured to have an icon 302 as an indicator for discovery of mobile applications available on a server. It would be evident to one skilled in the relevant art, however, that an indicator for discovery of mobile application can be a key, text or any other means.

By using the discovery icon 302, user of the electronic communication device reaches an application discovery-screen 303. The application-discovery screen 303 has icon 305 to initiate the discovering of mobile applications on the server. The application-discovery screen 303 also has icon 304 to cancel the process for discovery of mobile application and returns the user to home screen 301 of the electronic communication device. In addition, the application discovery-screen 303 also has icons 306 which the mobile user might have used previously. Discovery icon 305, leads to screen 307, which shows the progress for discovery of mobile applications, while the process for discovery of mobile applications takes place on the server. The screen 307 has a progress bar 308 depicting the progress on discovery of mobile applications from the server. Icon 304 would cancel the process of discovery of mobile applications and returns the user to screen 301.

Out of the plurality of discovered mobile applications, some may be of immediate interest to user while others are likely to be used in future. By icon 309, the user has the option of saving discovered mobile applications for future use. Further, the electronic communication device can have a pre-determined list of mobile applications hosted on the server. The user of the electronic device by using icon 302 would then automatically come to screen 310. Screen 310 makes available to the user on the display of his electronic communication device the list of discovered mobile applications or preconfigured list of mobile application. The mobile applications can be, but not limited to, software for upgradations, new installation setups, new mobile applications, voice calling, text messaging etc. The mobile applications can also be presented by means of graphical icons, text, images or by any other means. The user may not be satisfied with the results of discovery process and may desire to re-initiate the process for discovery of mobile applications, this can be done by icon 312. The user may select from the list of plurality of mobile applications, for example, the user selects ‘AP6’ 311. The user interface 314 of the selected mobile application 311 is transmitted from the server onto the display of the user's electronic communication device. The user inputs, data or commands, for execution of the selected mobile application 311 by the server.

The execution of the selected mobile application 311, is done on the server and the outputs of the execution are pushed onto the display 313 of electronic communication device. The mobile application 311, may get added to either the home screen 301 or the application discovery—screen 303. Throughout these interactions, user only receives user graphical interface screens 303, 307, 310 and 313 from the server to his electronic communication device, while execution of selected mobile application 311 takes place in server itself Complete management of mobile applications, home screen and discovery of the mobile applications application is done by server and thus the user's electronic communication device is generic and independent of mobile application that user executes. Further, the electronic communication device interacts only with the mobile applications to display the output (typically GUI) of the mobile application on electronic communication device and to provide inputs for execution of the selected mobile application (text, keystrokes) from electronic communication device to network server. There will not be any application download or application logic execution on the electronic communication device. Complete mobile application execution will be handled by the server.

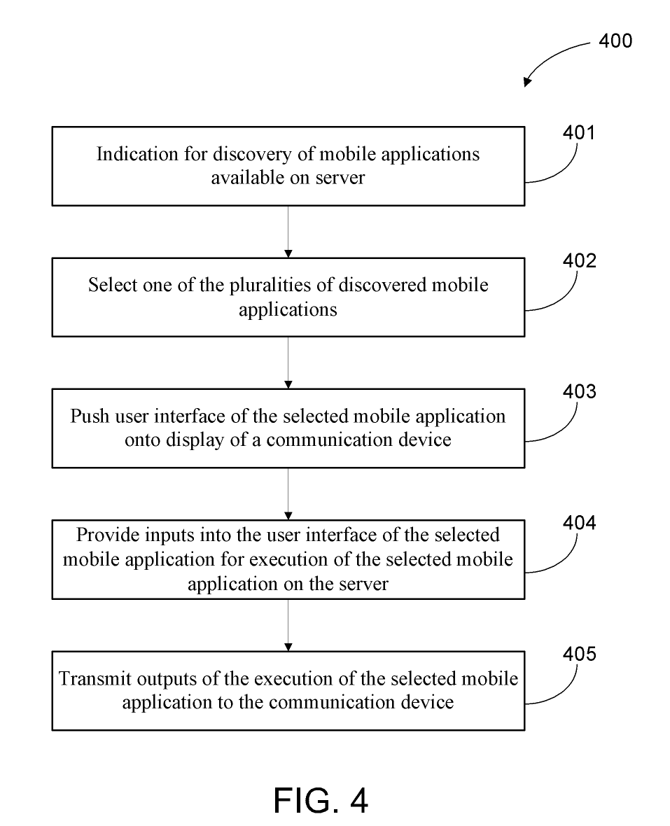

FIG. 4 illustrates a flow diagram 400 for a method of implementing mobile applications on a server. Method 400 includes at 401 receiving from an electronic communication device, an indication for discovery of mobile applications available on the server. An indication for discovery of electronic communication device at 401 includes a text, a keystroke, a physical force or any other means to initialize the discovery of mobile applications on the server. Method 400 further includes at 402 selecting from the electronic communication device one of the plurality of discovered mobile applications on the server. Further, the electronic communication device can have a pre-determined list of mobile applications hosted on the server, in which case 401 will not be needed. The user of the electronic device can select one of the pluralities mobile applications from the preconfigured list.

Based on user selection, at 403 the user interface of the selected mobile application is pushed on to the display of user device. The method 400 also includes at 404, providing inputs for execution of the selected mobile application. The inputs for execution of the mobile applications are provided through the user interface received at 403. As described above, the process for discovering and execution of mobile applications is done solely at the server and only the graphical user interface of the selected mobile application is pushed on the electronic communication device, thereby making the electronic communication device independent of the mobile applications. Based on inputs received at 404 for execution of the selected mobile application, the method 400 further includes at 405 transmitting outputs from the execution of the selected mobile application to the electronic communication device.

Those skilled in the art, will appreciate, that the invention may be practiced in any network computing environment where local and remote processing devices are linked (either by hardwired links, wireless links, or by a combination of hardwired or wireless links) through a communications network. The network computing environment may consist of electronic communication device like computer system configurations, including personal computer assistants, hand-held devices, multiprocessor systems, microprocessor-based or programmable consumer electronics, network PCs, minicomputers, mainframe computers, and the like. The invention may also be practiced in distributed computing environments. Moreover, it should also be understood that the embodiments within the scope and spirit of the invention may also include computer-readable media for carrying or having computer-executable instructions or data structures for implementing mobile applications on the server.

Thus, systems and methods for implementing mobile applications on a server have been described. It would be evident to person skilled in the art that various modification and changes may be made to these embodiments without departing from the broad spirit and scope of the invention. Further, the described embodiments and the drawings are to be considered only as illustrative and not restrictive.

We claim:

1. A communication system having mobile applications implemented on a server, comprising:
a server component that facilitates atleast one of: creation, installation, upgradation, distribution, customization, maintenance, execution, removal or discovery of the mobile applications on the server;
a client component with a user interface and a display that facilitates interaction with the server component; and
a communication component that facilitates communication between the server component and the client component.

2. The system of claim 1, wherein the server component facilitates creation, installation, distribution, upgradation, maintenance, execution, removal or customization of user interfaces of the mobile applications on the client component.

3. The system of claim 1, wherein the server component facilitates simultaneous executions of multiple mobile applications.

4. The system of claim 1, wherein the client component interacts with the mobile applications to display user interface of the mobile application on the client component and to provide inputs for execution of the mobile application from the client component to the server component.

5. The system of claim 4 wherein the inputs for execution of the mobile application is atleast one of: text, keystroke or any other indicator.

6. The system of claim 1, wherein the client component facilitates an indicator for discovery of mobile applications on the server.

7. The system of claim 1, wherein the client component facilitates an indicator for selection of the mobile applications on the server.

8. The system of claim 7, wherein the selected mobile applications are executed by the server component on the server.

9. The system of claim 8, wherein the server component facilitates transmission of outputs from the execution of the selected mobile application.

10. The system of claim 1, wherein the client component facilitates initialization and cancellation of discovery of mobile application.

11. The system of claim 1, wherein the server component facilitates the access to the mobile applications on predetermined parameters.

12. The system of claim 1, wherein the client component is an electronic communication device.

13. The system of claim 1, wherein the communication component is based in parts: fixed or wireless network.

14. A method of implementing a mobile application on a network server over a network, comprising:
receiving from a communication device an indication of discovering mobile applications on the network server;
selecting from the communication device one of the plurality of discovered mobile applications on the network server;
receiving from the network server user interface of selected discovered mobile applications to the communication device;
providing inputs using the user interface of selected discovered applications on the communication device for execution of the selected discovered applications on the network server; and
transmitting from the network server outputs of the execution of the selected discovered mobile applications.

15. The method of claim 14 wherein the network server facilitates creation, installation, distribution, upgradation, maintenance, execution, removal or customization of the mobile applications on the communication device.

16. The method of claim 14 wherein the network server facilitates creation, installation, distribution, upgradation, maintenance, execution, removal or customization of user interfaces of the mobile applications on the communication device.

17. The method of claim 14, wherein the network server facilitates simultaneous executions of multiple mobile applications.

18. The method of claim 14 wherein the selected mobile applications are executed by the network server.

19. The method of claim 14 wherein the interaction between the communication device and the mobile applications includes displaying user interfaces of the mobile applications on the communication device and providing inputs on execution of the mobile application from the communication device to the network server.

20. The method of claim 14 wherein the inputs for execution of the mobile application is atleast one of: text, keystroke or a user initiated indicator.

21. The method of claim 14 wherein the discovered mobile applications are displayed on the communication device based in parts: a graphic or text.

22. The method of claim 14 wherein the communication device facilitates indication for discovery of mobile applications on the network server.

23. The method of claim 14 wherein the communication device facilitates initializing and canceling of discovery of mobile application.

24. The method of claim 14 wherein the communication device is a mobile or fixed line phone.

25. A community based centralized system to manage and implement mobile applications, comprising:
a server, the server comprising:
a plurality of mobile application;
a first software application for at least one of: creation, installation, execution, upgradation, distribution, customization, maintenance, removal or discovery of the mobile applications;
a second software application for at least one of: creation, installation, execution, upgradation, distribution, customization, maintenance, removal or discovery of user interface of the mobile applications;
a plurality of communication device with display, the communication device comprising:
an indicator to exhibit on the display of the communication device, a plurality of icons, each icon providing an identification of one of the mobile applications; and
a network to facilitate data flow between the plurality of communication device and the server;
wherein upon selecting one of the icons, user interface of the indicative mobile application is displayed on the display of the communication device to facilitate inputs for execution of the mobile application on the server and based on the inputs, outputs of the execution of the mobile application are pushed over the network to the communication device.

26. The system of claim 25, wherein the interaction between the communication device and the mobile applications includes displaying user interface of the mobile applications on the communication device and providing inputs for execution of the mobile application from the client component to the server component.

27. The system of claim 26, wherein the inputs for execution of the mobile application is atleast one of: text, keystroke or an indicator.

28. The system of claim 25, wherein the server performs simultaneous executions of multiple mobile applications.

29. The system of claim 25, wherein the indicator initializes the discovery of mobile applications on the server.

30. The system of claim 25, wherein the communication device is configured to initialize and cancel the discovery of mobile applications on the server.

31. The system of claim 25, wherein the communication device is a fixed line device or a wireless device.

32. The system of claim 25, wherein the network is based in parts: fixed or wireless network.

33. The system of claim 25, wherein the plurality of icons are based in parts: text or image.

34. The system of claim 25, wherein the discovered mobile applications are executed by the server.

35. The system of claim 25, wherein the selected mobile applications are executed by the server.

36. A method of implementing a mobile application on a server over a network, comprising:
selecting from the communication device atleast one of the pluralities of mobile applications from a predetermined list of mobile applications hosted on the server;
receiving from the server user interface of selected mobile applications to the communication device;
providing inputs using the received user interface of selected mobile applications on the communication device for execution of the selected mobile applications on the network server; and
transmitting from the network server outputs of the execution of the selected mobile applications.

37. The method of claim 36, wherein the server is configured to create, install, distribute, upgrade, maintain, execute, remove or customize the mobile applications on the communication device.

38. The method of claim 36, wherein the server is configured to perform simultaneous executions of multiple mobile applications.
